(19) United States
(12) Patent Application Publication
(10) Pub. No.: US 2001/0051630 A1
(43) Pub. Date: Dec. 13, 2001

(54) Use of hydroxylamine derivatives, and method and preparations for increasing the tolerance of field crops against weather stresses

(76) Inventors: Andrea Jednakovits, Szentendre (HU); Gabor Galiba, Martonvasar (HU); Laszlo Urogdi, Budapest (HU); Jeno Szilbereky, Budapest (HU); Ede Marvanyos, Budapest (HU); Gabor Kocsy, Szekesfehervar (HU); Laszlo Stehly, Budapest (HU); Tamas Berzy, Martonvasar (HU); Mihaly Barabas, Budapest (HU); Zita Csakai, Kunszentmiklos (HU); Magdolna Torok, Mateszalka (HU)

Correspondence Address: Finnegan, Henderson, Farabow,, Garrett & Dunner, L.L.P., 1300 I Street, N.W., Washington, DC, 20005-3315, US

(21) Appl. No.: 09/756,780

(22) Filed: Jan. 10, 2001

Related U.S. Application Data
(63) Continuation-in-part of application No. 09/403,391, filed on Mar. 7, 2000, now abandoned.
Application No. 09/403,391 is a 371 of international application No. PCT/HU98/00039, filed on Apr. 21, 1998.

(30) Foreign Application Priority Data
Apr. 22, 1997 (HU) P 97 00792
Dec. 5, 1997 (HU) P 97 02365

(51) Int. Cl. A01N 43/40; A01N 43/54; A01N 33/00

(52) U.S. Cl. 514/272; 504/248; 504/326

(57) ABSTRACT

This invention relates to the use of hydroxylamine derivatives of general formula (I), wherein R¹ represents phenyl, N-heteroaryl, S-heteroaryl or a naphthyl group any of which may be unsubstituted or substituted, an unsubstituted or substituted phenylamino or alkylamino or lower alkoxy; X represents halo, amino or an unsubstituted or substituted phenylamino group, or amino substituted with one or two lower alkyl or a hydroxy group, provided that if R¹ represents unsubstituted or substituted phenylamino, alkylamino or lower alkoxy, then X is not halo; Y represents hydrogen, hydroxy or alkanoyloxy, with the proviso that simultaneously R¹ may not represent phenyl, halophenyl, alkoxyphenyl, N-heteroaryl or naphthyl, X may not represent halo, hydroxy or amino and Y may not represent hydrogen or hydroxy; R² and R³, independently from each other, represent hydrogen or lower alkyl group, provided that R² and R³ are not hydrogen simultaneously, or R² and R³ along with the adjacent nitrogen atom form a 5- to 7-membered saturated hetero ring, to increase the tolerance of cultivated plants against weather condition stresses, such as cold, frost and drought.

This application is a continuation-in-part of U.S. application 09/403,391, filed Oct. 21, 1999, now abandoned, which is a §371 of PCT/HU98/00039 filed Apr. 21, 1998, and claims benefit of priority of Hungarian patent applications HU P 97 00792, filed Apr. 22, 1997, and HU P 97 02365, filed Dec. 5, 1997. Each of the foregoing applications are hereby incorporated by reference.

### TECHNICAL FIELD

This invention relates to the use of hydroxylamine derivatives of general formula (I),

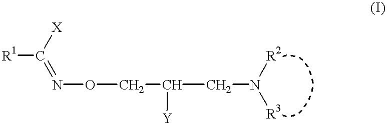

wherein

R′ represents phenyl, N-heteroaryl, S-heteroaryl or a naphthyl group which may be substituted with one or more halo, alkyl, alkoxy, halo alkyl or nitro, an unsubstituted or substituted phenylamino or alkylamino or lower alkoxy,

X represents halo, preferably chloro or bromo, amino or an unsubstituted or substituted phenylamino group, or amino substituted with one or two lower alkyl or a hydroxy group provided that if R¹ represents unsubstituted or substituted phenylamino, alkylamino or lower alkoxy, then X may not represent halo,

Y represents hydrogen, hydroxy or alkanoyloxy, preferably longer alkanoyloxy, with the proviso that simultaneously

R¹ may not represent phenyl, halophenyl, alkoxyphenyl, N-heteroaryl or naphthyl,

X may not represent halo, hydroxy or amino and

Y may not represent hydrogen or hydroxy;

R² and R³ independently from each other, represent hydrogen or lower alkyl group provided that R² and R³ may not represent hydrogen simultaneously, or R² and R³ along with the adjacent nitrogen atom form a 5 to 7-membered saturated hetero ring,

and the method and preparation for increasing the tolerance of cultivated plants against weather condition stresses.

### BACKGROUND ART

Damages to cultivated plants by weather stresses, such as cold, frost and drought cause significant losses for the agriculture. These factors, within this invention briefly referred to as weather stresses, may occur in any period of the growth or vegetation of the plant. Although they affect the plants in various ways and the plants react to them differently according to species and type, the effect is usually connected to the water metabolism of the plants. The protection of plants against weather stresses is made more difficult by the widely varied distribution of the time, strength and length of these stresses present at most agricultural regions.

In the present invention a temperature is considered cold if it is less than the minimum temperature necessary for normal physiological functioning of the individuals belonging to a given plant species or type, but greater than the freezing point of the water. Generally its effect may not be determined immediately by simple observation. The damage caused by the cold appears later, after warming up, such as the decrease in plant growth, the withering or fading (chlorosis), or in the most severe cases, death of the plant.

The frost, i.e. the temperature below zero degrees centigrade, does not necessarily cause the plant to perish. After it is gone, the plant may be regenerated but the irreversible cell damages caused by the frost will strain its development, which will decrease its yield in the end.

While the cold and the frost usually appear at an early stage of plant development and hence damage the germinating or developing plant, the drought damages the fully developed plant and endangers the further stage of development. Decreasing the evaporation level of the plant may render the reduction of the losses. For example there exists a method, when the surface of the plant is coated with a polymer film in order to physically limit the transpiration of the plant in the case of drought. For this purpose polyethoxylated polyoxypropylene copolymers described in the U.S. Pat. No. 4,828,602 are applied. The disadvantage of the method is that it requires a local application of the coating material, which may be done only by investing a great amount of manual labour. A durable transpiration inhibition is not desirable anyway; the system-effect transpiration inhibitors are more favourable with respect to plant physiology.

Thorough research related to the effects of the weather stresses on plants has been performed to reduce the damages of the cold, frost and drought, and a great number of scientific publications deal with the plant physiological relevance of cold, frost and drought tolerance. Since plants react to these weather stresses very differently according to their botanical characteristics, a theoretically satisfactory explanation of the mechanism of the cold, frost and drought tolerance has not yet been given, and hence the methods developed for application in practice to improve the tolerance of plants against weather stresses are very diverse.

For example, it is known in the art that growth regulating materials, which are compounds of hormonal activity, affect the cold, frost and drought tolerance of plants positively, and therefore they are applied for the treatment of cultivated plants. A typical example is abscisic acid, which is a growth regulating hormone. Abscisic acid itself is difficult to synthesize and hence it is not applied in agriculture. However, materials analogous to abscisic acid chemically and in their effect are used, which have identical or stronger effect than the abscisic acid itself, especially when combined with other compounds, which ensures a synergetic increase in the effect. For example, the PCT publication WO No. 9608481 A1 describes that plants are treated with epoxycyclohexane derivatives so as to make their development and yield more favorable and to increase their tolerance against cold and drought. Besides these compounds, brassidosteroids are also used as synergetic auxiliaries. The EP No. 327909 A1 describes a compound that contains a poly-substituted cyclohexenyl-acetylene derivative as an effective agent, and a diversely and multi-substituted phenyl-benzylurea derivative as synergetic auxiliary. With the help of this substance of hormonal activity, the tolerance of the plant against drought may be improved.

Compounds of hormonal activity are without any doubt significant, because they have an intense effect even when applied in small quantity, however their disadvantage is that they affect the metabolic processes taking place in the plants to a large extent, modify the hormonal equilibrium of the plants, which may result in unpredictable physiological changes. Therefore such compounds and products must be applied with care in practice. Before application, it is essential to perform preliminary experiments related to a given plant species or type in order to determine the suitability and optimal application circumstances of the product in a given agricultural region, which limits their use in agricultural practice.

To avoid the above mentioned disadvantages of substances of hormonal activity, researchers turned to simpler, hormonally indifferent substances to find a suitable effective agent to improve the tolerance of plants against cold, frost and drought. According to the PCT publication WO No. 92/08350 A1, tetrahydro-furfaryl-alcohol, tetrahydro-furfuryl-amine, or the combination of these compounds is applied to improve the tolerance of plants against cold. These effective agents lack the mentioned disadvantages of substances of hormonal activity, their production is easier, and hence they are more economical, but in view of the practice they are not favorable. This is because, according to the paper cited above, it is recommended to spray the plants more than once with the solution of the effective agent in order to achieve a satisfactory extent of regeneration of the cold-affected plants, and to repeat the treatment after the cold is gone, but the most expedient way is to spray the plants regularly. A treatment of the whole surface is considered important to ensure the contact of the effective agent on the entire surface of the plant. Therefore, thorough or repeated spraying is recommended. This requirement may be fulfilled only by investing a great amount of manual labor.

According to Hungarian Patent No. 181241, secondary or tertiary β-hydroxyethyl-amines or respective quaternary ammonium salts, preferably 2-hydroxy-ethyl-amines and trimethyl-β-hydroxy-ethyl-ammonium-chloride (choline-chloride) and, in certain cases, combinations of these may be applied to improve the tolerance of plants against cold and frost. Primarily, the effective agent is applied to the plant by spraying. It may be concluded from the experimental section of the Patent that the effective agent is aimed at changing the phospholipid composition of the membrane of plant cells, and thus the fluidity of the membrane. Hence the mentioned effective agents may be applied for the treatment of fully developed plants only. This was supported by the experimental results as well. The treatment of seedlings and seeds, which is mentioned in the Patent may not be effective with these effective agents since the plants lack the parts with the necessary membrane. An exception is choline-chloride, the application of which for treatment of seeds is known from the publication JP No. 62161701. In this case, however, the general growth regulating effect of the substance is utilised, as described in the above mentioned paper, and this effect causes among others the improved tolerance of the sprouting plant against cold. However, the growth regulating substances of hormonal activity possess all of the disadvantages described above.

To sum up the above, we may conclude that several different attempts have been published in Patent literature aimed at improving the tolerance of cultivated plants against weather stresses. The effective agents and products of these Patents are, however, suitable for direct agricultural application only with the mentioned limiting conditions.

Our research was aimed at finding effective agents, which increase the cold, frost and drought tolerance of plants but are hormonally neutral, non-toxic, the limits of their application being the smallest possible, and which are suitable not only for the treatment of fully developed plants but also of seedlings and seeds.

### DISCLOSURE OF INVENTION

It was found that the hydroxylamine derivatives of general formula (I), wherein

R¹ represents phenyl, N-heteroaryl, S-heteroaryl or a naphthyl group which may be substituted with one or more halo, alkyl, alkoxy, haloalkyl or nitro, an unsubstituted or substituted phenylamino or alkylamino or lower alkoxy,

X represents halo, preferably chloro or bromo, amino or an unsubstituted or substituted phenylamino group, or amino substituted with one or two lower alkyl or a hydroxy group provided that if R¹ represents unsubstituted or substituted phenylamino, alkylamino or lower alkoxy,

then X may not represent halo,

Y represents hydrogen, hydroxy or alkanoyloxy, preferably longer alkanoyloxy, with the proviso that simultaneously

R¹ may not represent phenyl, halophenyl, alkoxyphenyl, N-heteroaryl or naphthyl,

X may not represent halo, hydroxy or amino and

Y may not represent hydrogen or hydroxy;

R² and R³, independently from each other, represent hydrogen or lower alkyl group provided that R² and R³ may not represent hydrogen simultaneously, or R² and R³ along with the adjacent nitrogen atom form a 5 to 7-membered saturated hetero ring,

may show the desired effect and may exhibit the mentioned characteristics.

These compounds act in an inductive manner, i.e. they increase the level of hardiness if the plant faces environmental stresses, as when the above mentioned weather stresses affect the plant. The inducted metabolic processes result in an improved tolerance against cold, frost and drought.

Based on this observation, this invention relates to the use of hydroxylamine derivatives of general formula (I), where R¹, X, Y, R² and R³ are as above, for the improvement of the tolerance of cultivated plants against weather stresses.

In general formula (I), a lower alkyl group contains preferably 1-6 carbon atoms, most preferably 1-4 carbon atoms, and a lower alkoxy group contains 1-6, preferably 1-4 carbon atoms. In compounds of general formula (I), where R¹ is a substituted phenyl or phenylamino group, the alkyl groups attached to the phenyl ring as substituents are preferably lower 1-6 carbon atom alkyl groups. The alkoxy substituents of the phenyl ring preferably contain 1-6 carbon atoms. The haloalkyl substituents of the phenyl ring contain preferably alkyl, most preferably C₁₋₆ alkyl Most preferable haloalkyl substituent is the trifluoromethyl group. If R¹ represents alkylamino, it preferably contains at most 12 carbon atoms. If R¹ represents N-heteroaryl, it is preferably pyridyl or pyrazinyl group, while if R¹ represents an S-heteroaryl group, it is preferably thienyl. Finally, if Y represents a long carbon chain alkanoyloxy, it preferably contains 12-20 carbon atoms.

Some of the hydroxylamine derivatives of general formula (I) are known compounds. Those compounds of general formula (I), in which R¹ represents phenyl or alkoxyphenyl or pyridyl or naphthyl, X represents halo and Y is hydroxy, as well as their preparation are known from Hungarian Patent No. 207.988. These compounds may be applied in the therapy of angiopathy. Those compounds of general formula (I), in which R¹ represents haloalkylphenyl, X is hydroxy and Y represents hydroxy, are known from published Hungarian Patent Application No. 2385/92. These compounds have antiischemic and antianginal effect, and hence may be applied particularly in the therapy of heart diseases. Those compounds of general formula (I), in which R¹ represents phenyl or phenyl group substituted by the above listed substituents or a pyridyl group, X represents halo and Y is a hydrogen atom, are known from the PCT publication WO No. 95/30649 A1. The same document describes the preparation of these compounds. These compounds have antiischemic effect and hence may be applied in the therapy of diabetic angiopathy. Furthermore, those compounds of general formula (I) are also known, in which R¹ represents phenylamino which is unsubstituted or substituted with alkyl, alkoxy, halo, haloalkyl or nitro, or an alkoxy or alkylamino group, X represents hydroxy and Y is hydrogen, hydroxy or alkanoyloxy. Their description may be found in the PCT publication WO No. 97/00251, which describes the preparation of these compounds as well. These compounds have antiischemic effect and hence may be applied in the therapy of heart and blood vessel diseases. Note that in the known compounds R² and R³ represent the same as defined above, and therefore these two substituents are not described in detail.

It should also be noted that in certain compounds of general formula (I) tautomery may occur, i.e. they may appear in a tautomeric structure different from but corresponding to the formula (I). In particular, this is the case when compounds of general formula (I) contain a hydroxy group as X, where the tautomeric version containing a —(CO)—NH— molecule part not appearing in the structural formula is more stable.

New compounds are hydroxylamine derivatives of general formula (I), in which X represents halo, Y is hydroxy, and R¹ represents a group that is different from the ones described in the above mentioned Hungarian Patent No. 207.988 dealing with these kinds of compounds, for example phenyl substituted with alkyl, haloalkyl or nitro. These substances are prepared analogously to the cited description by diazotating the corresponding compound containing a NH₂ group in the place of X. The necessary starting amino compounds are produced also by known method, by the coupling reaction of the corresponding amidoxime and a 3-amino-2-propanol derivative, for example according to the method described in the Hungarian Patent No. 177.578.

N-substituted amidoximes of general formula (I), where R¹ represents an aromatic group and X represents a substituted amino group, are novel compounds. Preferably, this group of compounds comprises compounds of the general formula (I), wherein R is phenyl which is unsubstituted with one or more halo, alkyl, haloalkyl and nitro, X is unsubstituted or substituted phenylamino, Y is hydrogen, hydroxy or alkanoyloxy, R² and R³ independently from each other are H or lower alkyl provided that at least one of them is not hydrogen, or R² and R³ together with the nitrogen to which they are bonded, form a 5- to 7-membered saturated hetero ring. Within this group, preferred compounds include N-{(3-(1,1-dimethyl-ethyl)-amino)-2-hydroxy-propoxy}-N′-phenyl-benzamidine hydrochloride and N-(3-(1-piperidinyl)-propoxy)-N′-phenyl-benzamidine hydrochloride. These compounds may be produced by the coupling reaction of a suitable imidoyl-halide of general formula (1),

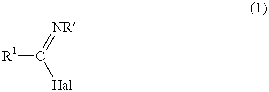

wherein Hal represents a halo and R¹ is as above, while R′ is the substituent of the amino group of X, and a 1-amino-3-aminooxy-propane derivative of general formula (2),

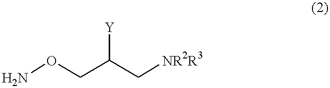

where R², R³ and Y are as above. The reactions should be performed in a neutral solvent, for example in chlorinated hydrocarbon, at room temperature and after extraction separation, the product is isolated as a salt with a suitable organic or inorganic acid.

Other novel compounds of general formula (I) are N-hydroxyguanidine derivatives in which both R¹ and X are substituted nitrogen atoms. These derivatives are produced by the acylation of a suitable aminooxy compound of general formula (2), if the acylating agent is haloformamidine of general formula (3),

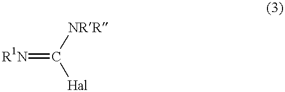

where Hal represents halogen, R¹ is as above, and R′ and R″ are substituents of the amino group appearing as X in the product. The reaction is performed in a two phase system, in the mixture of some organic solvent not mixable with water and an aqueous base, preferably aqueous sodium-carbonate solution. The product is isolated in this case also by extraction separation and, if possible, by salt-formation.

Any of those new compounds of general formula (I), in which Y represents alkanoyloxy may be produced by O-acylation of the corresponding compound containing hydroxy as Y. The starting compounds are either known from the above mentioned literature or may be produced according to the method described.

As acylating agent, acid halides, active esters or other usual reagents applicable for O-acylation may be used. The reactions can be performed in a neutral solvent, usually at room temperature and if necessary in the presence of a suitable acid-binding agent, such as an organic or inorganic base, for example triethylamine or solid sodium carbonate. For acylating agent, the acid chlorides are preferable, where the compound itself may behave as acid-binding agent, and hence usually the product may be easily isolated in the form of hydrochloride by simple ethereal crystallisation after evaporation. When using less reactive acylating agents, Schotten-Baumann acylation may also be applied. The products are generally isolated in the form of their salt with a organic or an inorganic acid.

With respect to the application of the invention, most preferable compounds were the following ones of general formula (I):

N-[2-hydroxy-3-(1,1 -dimethylethyl-amino)propoxy]-3-trifluoromethyl-benzamide monohydrochloride (Compound 1)

N-[2-palmitoyloxy-3-(1-piperininyl)propoxy]-3-pyridinecarboximidamide monohydrochloride (Compound 2)

N-[3-(1-piperidinyl)propoxy]-3-nitro-benzimidoyl-chloride monohydrochloride (Compound 3)

N-[2-hydroxy-3-(I-piperidinyl)propoxy]-2′-nitro-benzimidoyl-chloride monohydrochloride (Compound 4)

N-[[3-(1,1-dimethylethyl)-amino]-2-hydroxypropoxy]-N′-phenyl-benzamidine hydrochloride (Compound 5)

N-N′-dimethyl-N′-phenyl-N″-[3-(1-piperidinyl)propoxy]-guanidine hydrochloride (Compound 6)

N-[2-hydroxy-3-(1-piperidinyl)propoxy]-ethylurethane (Compound 7)

N-hexyl-N-[2-hydroxy-3-(1-piperidinyl)propoxyl]-urea (Compound 8)

N,N-dimethyl-N′-phenyl-N″-[2-hydroxy-3-(1-pipelidinyl)propoxy]-guanidine hydrochloride (Compound 9)

N-[3-(1-piperidinyl)propoxy]-thiophene-2-carboximidoylchloride hydrochloride (Compound 10)

N-[3-(1-piperidinyl)propoxy]-N′-phenyl-benzamidine hydrochloride (Compound 11)

Compounds of general formula (I) are favourable with respect to application in the cultivation of plants because they are suitable for treating both the fully developed plant and the seed or the seedling. These compounds may be applied to the plants using any of the usual procedures widely used in plant-protection.

Based on the above, the invention relates to a procedure to increase the tolerance of cultivated plants against weather stresses. According to the invention, the protected plant or its seed is treated with a hydroxylamine derivative of general formula (I), where R¹, X, Y, R² and R³ are as above. Preferably an aqueous solution of the compound of general formula (I) is used for the treatment, but alternatively a preparation containing the usual carriers and the hydroxylamine derivative of general formula (I) as effective agent may be applied.

The dose and the concentration of the effective agent of general formula (I) is dependent on the protected plant species or type and on the method of the application.

If the procedure according to the invention is aimed at improving the tolerance of the plant against cold and frost, preferably the seed of the plant should be treated with a hydroxylamine derivative of general formula (I), where R¹, X, Y, R² and R³ are as above. The seed of the plant must be covered with the proper product containing the active agent and suitable for coating, preferably pearled, in certain cases dressed, or the aqueous solution of the effective agent may simply be used.

The preferable method is to soak the seed of the plant in an aqueous solution of a compound of general formula (I). For this purpose a 1-200 mg/l concentration of the compound of general formula (I) in aqueous solution is prepared.

The procedure according to the invention may be performed by coating the seed of the plant with a solution containing a hydroxylamine derivative of general formula (I). The compounds of general formula (I) may be combined with dressing agents in certain cases.

For the coating of the seeds preferably pearling agents are applied, which contain compounds of general formula (I) in a concentration of 0.1-10 g/l along with the usual pearling and auxiliary materials. The pearling agents may contain other effective agents beside the mentioned effective agent as well, such as fungicides or additives promoting germination, for example microelements. The pearling agent is applied in a small volume. For example, when treating bean, soybean or maize seeds, only 1 ml or less amount of pearling agent is used for 100 seeds, which is dried on the seeds uniformly while constantly stirring.

Furthermore, this invention relates to a procedure for improving the tolerance of cultivated plants against cold, where the plant is sprayed before or at the time when the cold season sets in with a spray preparation containing a hydroxylamine derivative of general formula (I) as effective agent.

The spraying is performed with a 1-500 mg/liter concentration aqueous solution of the effective agent, which may occasionally contain spraying auxiliary materials, such as surface active material (detergent). In certain cases, compounds of general formula (I) may be combined and sprayed to the plant to be protected with other effective agents such as fungicides.

The spraying is to be performed at the beginning of the period hazardous in terms of cold temperature. If more than one period is to be taken into consideration, then the plants must be sprayed at the beginning of each such period.

According to the invention, to improve the tolerance of cultivated plants the plant must be sprayed before or at the time when the dry season sets in with a spray preparation containing a hydroxylamine derivative of general formula (I) as effective agent.

The spraying is performed using a 1-500 mg/l aqueous solution of the active agent. The plants to be protected are sprayed before or at the beginning of the period when there is a risk of drought. In every case, the characteristics of the given plant species or type determine the applicable quantity of the active agent. If more than one drought period is to be taken into consideration, then the spraying must be repeated at the beginning of each such period.

For the above listed treatments, a simple aqueous solution of the hydroxylamine derivatives of general formula (I) may be used. Preferably such preparations are used which contain proper auxiliary materials in addition to the active agent, for improving the spraying, distribution and the absorption of the active agent.

The composition of the invention for improving the tolerance of cultivated plants against weather stresses contains 0.001-95 m/m % hydroxylamine derivative of general formula (I), in which R¹, X, Y, R² and R³ are as above, beside the solid or liquid carriers and possible auxiliary materials suitable for agricultural application.

The composition preferably contains water as liquid vehicle agent. The aqueous solution of the active agent may be a concentrate, which should be diluted before application in order to prepare the proper concentration mentioned above. Preferably, the aqueous solutions contain surfactants, those solutions for treating the seed contain dressing and pearling auxiliary materials, such as film forming materials. The sprays may contain an adhesion improving agent, a substance to improve spreading, light protecting agent, if required, a stabilising agent and other additives beside the detergents. For spraying purposes ULV concentrates, emulsifiable concentrates, hydrophyl powders, soluble granulates or microgranulates dilutable with water may be applied. These products contain anionic or non-anionic detergents in order to help the dilution with water. The solid products may contain kaolin, diatomite or dolomite as vehicle, but may also contain any other solid vehicle agent widely applied in such products. Preferably, perlite is used as vehicle agent for the production of microgranulate.

The compositions of the invention may be combined or simultaneously applied with other pesticides, if the active agent of the latter is compatible with the active agent of the composition of the invention. In these cases, the spraying of the composition of the invention does not require a separate process, it can be performed along with the usual pesticide treatment of the cultivated plants.

### BEST MODE OF CARRYING OUT THE INVENTION

The invention is demonstrated by the following examples without limiting the scope of the invention.

### EXAMPLE 1

### N-[2-palmitoyloxy-3-(1-piperidinyl)propoxy]-3-pyridinecarboximidamide Monohydrochloride (Compound 2)

14.7 g (52.8 mmol) of N-[2-hydroxy-3-(1-piperidinyl) propoxy]-3-pyridine-carboximidamide is dissolved in 160 ml of chloroform. 7.7 ml (55 mmol) of triethylamine is added, followed by the dropwise addition of a solution of palmitoyl chloride (14.7 g; 56.5 mmol) in 85 ml of chloroform. The mixture is stirred overnight at room temperature. The next day, a further 3.8 ml of triethylamine and 7.4 g of palmitoylchloride are added, and the stirring is continued for one more day. Then the solution is extracted with water, 5 V/V % acetic acid and water, successively, dried over anhydrous sodium sulphate, and evaporated to dryness.

The residue (28.2 g oil) is dissolved in ethyl acetate, and the product is precipitated by addition of 30 ml of 1 N HCl/ethyl acetate. The thick, white precipitate is filtered off, washed with ethyl acetate and dried.

Yield: 10.9 g (37%)

Mp.: 110-113° C.

### EXAMPLE 2

### N-[2-hydroxy-3-(1-piperidinyl)propoxy]-2′-nitro-benzenecarboximidoyl Chloride Monohydrochloride (Compound 4)

6.0 g (16.7 mmol) of N-[2-hydroxy-3-(1-piperidinyl) propoxy]-2′-nitro-benzene-carboximidamide monohydrochloride is dissolved in 21 ml of water, then 48 ml of concentrated hydrochloric acid is added. The solution is cooled to −5° C., then a cold solution of 2.1 g (33.3 mmol) of sodium nitrite in 9 ml of water is added dropwise. Throughout the reaction the internal temperature is maintained at 0° C. When the addition is completed, the mixture is stirred for a further four hours and cooled overnight. The product is filtered off, washed with cold water and dried.

Yield: 3.9 g (63%). Mp.: 159-162° C.

IR (KBr): 3298, 2983, 2932, 2746, 1593, 1574, 1535, 1445, 1391, 1354, 1317, 1288, 1242, 1198, 1117, 1092, 1069, 1020, 968, 947, 914, 852, 793, 756, 708, 577 cm⁻¹

### EXAMPLE 3

### N-[[3-(1,1-dimethylethyl)-amino]-2-hydroxypropoxyl-N′-phenyl-benzamidine Hydrochloride (Compound 5)

14 g (24.7 mmol) of benzanilide-imide-chloride is dissolved in 45 ml of chloroform. Then 5.32 g (24.7 mmol) of 1-aminooxy-3-[(1,1-dimethyl-ethyl)-amino]-2-hydroxy-propane dissolved in 45 ml of chloroform is added dropwise to the resulting solution. The reaction mixture is stirred at room temperature for 3 hours, and then washed with 25 ml of 1 M aqueous sodium-carbonate solution. The chloroform phase is dried over sodium-sulphate, filtered and evaporated. The evaporation residue is crystallised with hexane. The resulting base is dissolved in (5.33 g) 50 ml of ethyl-acetate and then 3.35 ml of 3.67 N hydrochloric acid/ethyl-acetate is added. The isolated crystals are filtered off, washed with ethyl-acetate and dried.

Yield: 2.97 g (72%). M.p.: 140-143° C.

¹H-NMR (solvent: CDCl₃; reference: CDCl₃ [ppm]): 9.7 (m,1H) and 8.1 (m,1H,NH₂⁺); 7.8 (s,1H,NH-O); 6.7-7.4 (m,10H,2×Ph); 5.7 (d,1H,OH); 4.5 (m,1H,CH); 4.25 (d,2H,OCH₂); 3.1 (m,2H,NCH₂); 1.25 (s,9H,^{t}Bu).

### EXAMPLE 4

### N-N′-dimethyl-N′-phenyl-N″-[3-(1-piperidinyl)propoxy]-guanidine Hydrochloride (Compound 6)

20 ml of 1 M aqueous sodium-carbonate solution is added to 1,040 mg (6.5 mmol) of 1-aminooxy-3-(1-piperidinyl)propane dissolved in 10 ml of ether. While intensely stirring, 1200 mg (6.5 mmol) of N,N-dimethyl-N′-phenyl-chloroformamidine dissolved in 10 ml of ether is added. After 2 hours of stirring, further 20 mg (0.1 mmol) of N,N-dimethyl-N′-phenyl-chloroformamidine is added. After further 3 hours of stirring, the phases are separated and the ethereal phase is dried over sodium-sulphate, filtered and evaporated. The residue (1700 mg of yellow oil) is dissolved in 10 ml of ethyl acetate. 10.5 ml of 0.54 M hydrochloric acid/ethyl-acetate is added, and then the product is cooled and the isolated crystals are filtered off. The raw product is crystallised from methanol-ether mixture to give 847 mg of white crystalline material.

Yield: 847 mg (38%). M.p.: 138-139° C. (methanol-ether)

¹H-NMR (solvent: CDCl₃; reference: CDCl₃ [ppm]): 7.2 (t,2H,Ph-m); 7.1 (d,2H,Ph-o); 6.9 (t,IH,Ph-p); 6.6 (m,1H,NH⁺); 4.0 (t,2H,OCH₂); 3.5 (m,2H); 3.0 (t,2H,CH₂); 2,6 (s,6H,2×NCH₃); 2.2-2.5 (m,6H,3×NCH₂); 1.8 (m,4H) and 1.3 (m,2H,piperidine). The product crystallised from isopropanol melts at 213-216° C.

### EXAMPLE 5

### N-[3-(1-piperidinyl)propoxy]-N′-phenyl-benzamidine Hydrochloride (Compound 11)

0.8 g (5 mmol) of 1-aminooxy-3-(1-piperidinyl)propane is dissolved in 7.5 ml of chloroform. 1.08 g (5 mmol) of benzanilide-imidechloride dissolved in 7.5 ml of chloroform is added dropwise and then the reaction mixture is stirred for 3 hours. Then it is washed with two times 10 ml of water, and the chloroform phase is dried over sodium sulphate, filtered and evaporated. The evaporation residue is dissolved in 20 ml of 2 N aqueous sodium-hydroxide solution and the solution is extracted with 20 ml of ethyl-acetate. The ethyl-acetate phase is dried over sodium-sulphate and filtered, and then 0.8 ml of 3.45 M hydrochloric acid/ethyl acetate is added. The isolated precipitate is filtered and dried.

Yield: 0.8 g (46%). M.p.: 164-166° C. (crystallised from ethyl-acetate)

C¹³-NMR (solvent: CDCl₃; reference: CDCl₃ [ppm): 157.55 (C-amidine); 135.75 (N-Ph-ipso); 132.84 (C-Ph-ipso); 128.95 (N-Ph-m); 128.84 (C-Ph-m); 126.66 (N-Ph-p); 125.34 (N-Ph-p); 124.0 (C-Ph-p); 74.02 (OCH₂); 54.20 (NCH₂); 53.30 (2.6 piperidine); 23.19 (CH₂); 22.63 (3.5 piperidine); 21.76 (4 piperidine).

### EXAMPLE 6

### N,N-dimethyl-N′-phenyl-N″-[2-hydroxy-3-(1-piperidinyl)propoxy]-guanidine hydrochloride (Compound 9)

1,150 mg (6.58 mmol) 1-aminooxy-2-hydroxy-3-(1-piperidinyl)-propane] is dissolved in 20 ml of ether and to this solution 20 ml of 1 M sodium carbonate solution is added, then 1,206 mg (6.58 mmol) of N,N-dimethyl-N′-phenyl-chloroformamidine dissolved in 10 ml of ether is added. After two hours, 22 mg (0.11 mmol) of N,N-dimethyl-N′-phenyl-chloroformamidine is also added to the reaction mixture. After stirring for further 3 hours, the layers are separated, the ether layer is dried over sodium-sulphate, filtered and evaporated. The residual 1,800 mg of yellow oil is taken in 10 ml of ethyl acetate, and to this solution 10.46 ml of 0.54 M HCl/ethyl acetate is added, cooled and the yellow crystals are filtered off. Impurities are removed by recrystallisation first in acetone; then in ethyl acetate.

Yield: 674 mg (28%) pale yellow powder. Mp.: 127-129 ° C. (ethyl acetate) ¹H-NMR (solvent: CDCl₃; reference: CDCl₃ [ppm]): 7.1-7.4 (m,5H,Ph); 5.9 (m,1H,OH); 4.6 (m,1H,CH); 4.1 (m,2H,OCH₂); 3.6 (m,4H,2-6 piperidine); 3.4 (m,2H); 3.2 (m,1H,NH); 1.8 (m,4H,3-5 piperidine); 1.4 (m,2H,4 piperidine)

### EXAMPLE 7

### Increasing Chilling Tolerance by Treating Seeds

In this experiment the tolerance of maize, soybean and pepper seeds treated with the active agent against cold was tested. This test imposed temperature and oxygen deficiency stresses on the seeds and was carried out according to Barla-Szabó and Dolinka CSVT (Complex Stressing Vigour Test). For a single test, two hundred seeds were soaked for 48 hours at 25° C. and another 48 hours at 5° C in 150 ml distilled water containing the active agent in 10 mg/l concentration. Following the 96 hours of soaking, the seeds were further germinated between rolled wet paper for 96 hours at 25° C. There were 25 seeds in each roll, the rolls were placed vertically into containers and covered with a plastic bag in order to reduce evaporation. During the whole procedure the seeds were kept in darkness.

At the end of the experiment the number of normally developing and ungerminated seeds were recorded. The length of the normal seedlings was measured and the average length of the five longest seedlings was calculated. Seedlings longer than 0.33 times the average length of the five longest seedlings were considered to be of high vigour, and low vigour seedlings were shorter than this length.

In experiments with maize, it was found that the tested active agents did not influence the germination and development of the Mo 17 inbred maize line germinated in optimal circumstances, at 25° C. Under the circumstances of the CSVT test, however, they proved to be effective, as it is shown in Table 1.

TABLE 1

| Active agent | Ratio of high vigour plants (%) |
|---|---|
| Compound 1 | 29* |
| Compound 7 | 24 |
| Compound 2 | 47* |
| Compound 8 | 23* |
| Compound 3 | 28* |
| Compound 4 | 32* |
| Compound 5 | 35* |
| Compound 6 | 36* |
| Control | 19 |

Results marked with * are significant compared to the control, if P < 0.05.

Using the same experimental method for the HMv09 inbred maize line compounds shown in Table 2., proved to be effective, the ratio of plants of high vigour increased significantly.

TABLE 2

| Active agent | Ratio of high vigour plants (%) |
|---|---|
| Compound 1 | 49* |
| Compound 3 | 40* |
| Compound 5 | 57* |
| Compound 9 | 56* |
| Compound 10 | 45* |
| Compound 11 | 53* |
| Control | 33 |

Results marked with * are significant compared to the control, if P < 0.05.

In the case of a further experiment with maize of low chilling tolerance (LT) and high chilling tolerance (HT) populations [Ref: P. Landi, E. Frascaroli, A. Lovato; EUPHYTICA 64 21-29 (1992)], the following positive effects were found (Table 3.).

TABLE 3

Ratio of high vigour plants %

| Active agent | HT | LT |
|---|---|---|
| Compound 1 | 98* | 94* |
| Compound 2 | 92* | 86* |
| Compound 3 | 94* | 88* |
| Compound 4 | 96* | 92* |
| Control | 84 | 74 |

Results marked with * are significant compared to the control, if P < 0.05.

Experiments with McCall soybeans also showed that the active agents have no effect on the germination and development of the plants under normal conditions. When applying the CSVT test, the following results were obtained (Table 4.).

TABLE 4

| Active agent | Ratio of high vigour plants (%) |
|---|---|
| Compound 1 | 43* |
| Compound 3 | 46* |
| Control | 38 |

Results marked with * are significant compared to the control, if P < 0.05.

Experiments with green peppers showed similarly that the active agents have no effect under normal circumstances, do not influence the germination of the seeds and the development of the plants kept at 25° C. Under the circumstances of the CSVT test, they increased the length of the sprouts and the roots along with the proportion of the high vigour seedlings. The ratio of the ungerminating seeds decreased by 30% on average due to the treatment with the active agents. The results are demonstrated in Table 5.

TABLE 5

| Active agent | Ratio of high vigour plants (%) |
|---|---|
| Compound 1 | 47* |
| Compound 3 | 45* |
| Control | 36 |

Results marked with * are significant compared to the control, if P < 0.05.

In order to make the results more comprehensible, it should be noted that the CSVT procedure is developed to predict the expected minimal ratio of sprouting seeds under environmental stresses. In a given set of seeds, the ratio of those seeds that safely sprout and properly germinate in cold spring weather is 90% for seeds which proved to be of high vigour in the CSVT test, while the ratio of those seeds which safely sprout and properly germinate in cold spring weather is only 60% for seeds that proved to be of low vigour in the test. Hence, if an active agent improves the vigour of the seedlings, it in the end improves the sprouting ratio under open field conditions in the case of ground temperature colder than optimal.

The above experiments prove that the compounds of general formula (I) are able to improve the vigour of the seedlings and hence improve the chance of sprouting, if unexpected weather stresses occur after the sowing.

### EXAMPLE 8

### Pearling of Soybean Seeds

Soybean seeds are treated with a pearling agent, which contains 1 mg/ml of N-[3-(1-piperidinyl)propoxy]-3-nitro-benzimidoyl-chloride monohydrochloride (Compound 3) in a 5% aqueous polyvinylalcohol solution. 100 seeds and 1 ml of pearling agent are filled into a glass vessel and while the vessel is rotated, the seeds are coated with the agent and then it is left to dry. For seeds treated this way, we obtained the following results when placed under the conditions of the CSVT test described in Example 7.

TABLE 6

Ratio of high vigour plants (%)

| Treatment | sprout | root |
|---|---|---|
| untreated control | 47 | 40 |
| pearled with PVA | 52 | 49 |
| pearled with PVA and | 63* | 58* |
| Compound 3 | | |

Results marked with * are significant compared to the control, if P < 0.05.

PVA slightly increased the ratio of high vigour plants. The PVA solution containing Compound 3 proved to be such a pearling agent which was able to increase the ratio of high vigour plants significantly under the experimental conditions, increasing the length of both the sprouts and the roots.

In a further CSVT experiment also using McCall soybeans, polyvinylalcohol (PVA) was applied for pearling the seeds. The 2.5 mg doses of the active agents were dissolved in 1 ml of 2.5% PVA solution, and this quantity was applied to 100 pieces of seeds. The improvement of the chilling tolerance is observed by the significant elongation of the germ and the roots. The results are demonstrated in Table 7.

TABLE 7

| | Relative length | (control = 100) |
|---|---|---|
| Active agent | germ | root |
| Compound 1 | 106 | 128 |
| Compound 2 | 133 | 150 |
| Compound 4 | 116 | 135 |
| Compound 5 | 127 | 152 |

The experiments show clearly that, according to the results of the vigour test, the chances of sprouting of the plants increased after pearling with the active agent.

### EXAMPLE 9

### Increasing the Drought Tolerance of Beans

Based on the experiences of our preliminary experiments, the plants were hardened before the application of the active agent by withholding the water for a few days, until the first signs of withering appeared. Then the plants were watered and the active agent was either dissolved in the water, or sprayed to the plants directly. Afterwards, the plants were subjected to different periods of drought according to the given experiment, watered again, and after a week-long regeneration period, the survival ratio was determined.

a) Seaway bean cultivar was hardened for 5 days by withholding the water. Afterwards the plantlets were watered for two days normally. During this time, a 10 mg/liter and 100 mg/liter concentration solution of the active agent was applied two times a day dissolved in water or by direct spraying. Then the water was withheld for 7 days, and after a week-long regeneration period, the survival ratio was determined. The results are summarised in Table 8.

TABLE 8

| | | Watering (100 mg/l) | Spraying |
|---|---|---|---|
| Active agent | Watering (10 mg/l) | survival (%) | (100 mg/l) |
| Control | 17 | 17 | 0 |
| Compound 1 | 30* | 41* | 71* |
| Compound 5 | 25* | 36* | — |

Results marked with * are significant compared to the control, if P < 0.05.

b) In this experiment, bean plants (cv. Seaway) were hardened for 7 days instead of the 5 days described in Part a. Then a 10 mg/liter and 100 mg/liter concentration solution of the active agent was applied two times a day for two days. Then 7 days without water followed, and after a week-long regeneration period, the results of the experiment were evaluated. The results are summarised in Table 9.

TABLE 9

| Active agent | Survival (%) |
|---|---|
| Compound 1 | 14* |
| Compound 3 | 39* |
| Control | 0 |

Results marked with * are significant compared to the control, if P < 0.05.

### EXAMPLE 10

### Increasing the Drought Tolerance of Soybeans

Soybeans of soybean cv. Bólyi 44 were hardened for 6 days by withholding the water. This was followed by two days of watering, and the active agent was applied in the water. The concentration of the solution of the active agent was 50 mg/liter. After a 4-day-long cease of watering and a one week regeneration period, the number of surviving plants was recorded. The results are listed in Table 1 0.

TABLE 10

| Active agent | Survival (%) |
|---|---|
| Compound 1 | 25* |
| Compound 3 | 33* |
| Control | 18 |

Results marked with are significant compared to the control, if P < 0.05.

Watering was ceased for 10 days for a certain group of plants in the experiment. It was observed that almost every plant perished. Each of the 4 surviving plants had previously been treated with the active agent.

### EXAMPLE 11

### Increasing the Frost Tolerance of Beans

Seedlings of bean cv. Seaway were cultivated under normal conditions for the first two weeks, then they were treated with 10 mg/liter and 100 mg/liter concentration solutions of the examined active agents 2 and 1 days before the initiation of the frost tolerance experiments. In the experiment, the plants were kept at −2° C. for 8 hours, then grew under normal conditions for I week, and the survival ratio was determined. 4 trays were used for each experiment and 6 seeds were planted in each tray. The compounds in Table 11. significantly increased the survival ratio.

TABLE 11

| Active agent | Treatment | Survival (%) |
|---|---|---|
| Compound 1 | spraying, 100 mg/l | 40* |
| Control | spraying | 25 |
| Compound 1 | watering, 10 mg/l | 25* |
| Compound 3 | watering, 10 mg/l | 40* |
| Control | watering | 18 |

Results marked with * are significant compared to the control, if P < 0.05.

### EXAMPLE 12

### Increasing the Chilling Tolerance of Maize in a Gradient Chamber

The experiment was performed using the Mo 17 maize inbred line. The seeds were coated with a 2% solution of the examined compound dissolved in 2 ml polyvinylalcohol before germination, where the above quantity of solution is applied for 100 seeds. The seeds were germinated for 3 days wrapped in wet filter paper, they were sown and then cultivated in gradient chamber for 6 weeks. In the gradient chamber, the temperature was maintained on a scale between 18 and 12° C., with differences of 1° C. This was followed by a one week regeneration at 23/20° C. temperature.

In the experiment, the length of the plants was measured 16, 31 and 43 days after the sowing, and at the end of the experiment the fresh weight of the plants was measured. The experiment was performed on 4 plants at each temperature and by each treatment. The results demonstrate the increased germination potential of the examined maize inbred line, and the improvement of the early development of the seedlings compared to the untreated control. The experimental results are summarized in Table 12.

TABLE 12
Increasing the chilling tolerance of maize in gradient chamber with
Compounds 1, 4 and 5

| | | Control | | Compound 1 | | Compound 4 | | Compound 5 | |
|---|---|---|---|---|---|---|---|---|---|
| | Time | Length | FW | Length | FW | Length | FW | Length | FW |
| Temp. | (days) | (cm) | (g) | (cm) | (g) | (cm) | (g) | (cm) | (g) |
| 18° C. | 16 | 12.9 | — | 13.2 | — | 15.0 | — | 14.6 | — |
| | 31 | 22.0 | — | 28.4 | — | 28.4 | — | 25.0 | — |
| | 43 | 35.0 | 5.3 | 37.0 | 6.0 | 38.0 | 6.2 | 39.0 | 7.6 |
| 17° C. | 16 | 13.1 | — | 17.0 | — | 19.7 | — | 17.8 | — |
| | 31 | 22.9 | — | 27.7 | — | 31.2 | — | 29.9 | — |
| | 43 | 36.0 | 4.8 | 36.5 | 5.5 | 37.3 | 6.6 | 44.3 | 9.7 |
| 16° C. | 16 | 10.2 | — | 15.2 | — | 15.4 | — | 12.4 | — |
| | 31 | 20.6 | — | 24.8 | — | 26.8 | — | 26.4 | — |
| | 43 | 33.1 | 4.2 | 32.3 | 4.5 | 34.5 | 5.0 | 42.3 | 7.7 |
| 15° C. | 16 | 9.2 | — | 10.0 | — | 10.2 | — | 9.5 | — |
| | 31 | 15.0 | — | 17.7 | — | 21.3 | — | 22.2 | — |
| | 43 | 21.2 | 2.0 | 28.5 | 3.6 | 32.3 | 4.4 | 34.0 | 5.4 |
| 14° C. | 16 | 5.2 | — | 7.6 | — | 9.7 | — | 5.8 | — |
| | 31 | 10.8 | — | 15.4 | — | 17.2 | — | 11.6 | — |
| | 43 | 20.3 | 1.6 | 25.9 | 2.7 | 25.1 | 2.9 | 20.3 | 1.3 |
| 13° C. | 16 | 5.0 | — | 6.0 | — | 7.4 | — | 4.7 | — |
| | 31 | 10.8 | — | 10.1 | — | 13.1 | — | 10.0 | — |
| | 43 | 17.2 | 1.0 | 16.0 | 1.0 | 23.8 | 2.1 | 18.5 | 1.1 |
| 12° C. | 16 | 5.4 | — | 5.0 | — | 5.8 | — | 4.5 | — |
| | 31 | 8.7 | — | 7.9 | — | 11.3 | — | 10.9 | — |
| | 43 | 17.8 | 0.9 | 18.9 | 1.2 | 20.1 | 1.5 | 25.5 | 2.0 |

In the following examples, results of field experiments are shown, which were arranged with early sowing in order to determine the effect of the hydroxylamine derivatives of the invention on the development and yield of the plants in this case under natural conditions.

### EXAMPLE 13

### Increasing the Yield of Field Soybean Cultivation

The experiment was performed using soybean cv. Bólyi 44. Before sowing, the seeds were treated with Rhyzobium Japonicum nitrogen-binding bacterium, which forms a root nodule providing 50-70% of the nitrogen demand of the plant.

The examined compounds were applied by pearling the seeds; 1 ml of pearling agent containing 1 mg of active agent in a 5% aqueous PVA solution was used for 100 seeds.

The plants were sown after soil preparation in the autumn, using a crop rotation system, 3-5 cm deep in the ground, with a 45-50 cm row distance, a 5 cm plant distance and 450,000-500,000 plant/ha density. The date of sowing was Apr. 15, 1997. During the development of the plant, the usual cultivation procedures were followed and the usual pesticides were used. The harvest took place in September-October, with the water content of the grains being between 16-18%. The results are listed in Table 13.

TABLE 13

| | | Improvement compared to |
|---|---|---|
| Active agent | Weight of the crop (kg/m²) | the control (%) |
| Control | 0.45 | |
| Compound 5 | 0.52 | 15.5 |
| Compound 4 | 0.50 | 11.1 |
| Compound 1 | 0.55 | 22.2 |

### EXAMPLE 14

### Increasing the Yield of Maize in Field Cultivation

The experiments were performed on the Mo 17 and AMO 406 lines. Before sowing, the seeds were dressed with fungicides, insecticides and rodent-control agents, and, at the same time, the tested compounds were applied in the form of a 2.5 mg/ml concentration solution in a 2% PVA solution; 2 ml of solution was used for 100 seeds.

The plants were sown after soil preparation in the autumn, using a crop rotation system, 4-8 cm deep in the ground, with a 45 cm row distance, a 30 cm plant distance and 60,000-80,000 plant/ha density. The date of the sowing was Apr. 15, 1997. During the development of the plant, the usual cultivation procedures were followed, and the usual pesticides were applied. Harvest took place when the water content of the grains decreased below 28%. At harvest, the weight of the plants and of the crop were determined. The results are listed in Table 14. and 15.

TABLE 14
Field cultivation of the Mo 17 maize line

| Active agent | | | | | |
|---|---|---|---|---|---|
| (Compound No.) | | Weight of the crop (kg/m²) | | Ratio to the control | |
| Control | 1^{st} | 1.55 | 100% | 0.09 | 100% |
| | 2^{nd} | 1.42 | 100% | 0.088 | 100% |
| 5 | 1^{st} | 2.03 | 130.9% | 0.101 | 112.2% |
| | 2^{nd} | 2.0 | 140.8% | 0.11 | 125% |
| 4 | 1^{st} | 1.97 | 127% | 0.109 | 121.1% |
| | 2^{nd} | | | 0.093 | 105.6% |
| 1 | 1^{st} | 1.85 | 119.3% | 0.108 | 120% |
| | 2^{nd} | 2.0 | 140.8% | 0.111 | 126.1% |

TABLE 15
Field cultivation of the AMO 406 maize line

| Active agent | | | | | |
|---|---|---|---|---|---|
| (Compound No.) | | Weight of the crop (kg/m²) | | Ratio to the control | |
| Control | 1^{st} | 1.65 | 100% | 0.097 | 100% |
| | 2^{nd} | 1.13 | 100% | 0.075 | 100% |
| 5 | 1^{st} | 2.2 | 133.3% | 0.115 | 118.5% |
| | 2^{nd} | 1.75 | 154.8% | 0.097 | 129.3% |
| 4 | 1^{st} | 1.8 | 109% | 0.1 | 103.0% |
| | 2^{nd} | 1.8 | 159.2% | 0.1 | 133.3.6% |
| 1 | 1^{st} | 2.35 | 140.6% | 0.16 | 164.9% |
| | 2^{nd} | 1.25 | 110.6% | 0.089 | 118.6% |

### EXAMPLE 15

### Foliar Spray

The foliar spray is prepared with the following composition (proportions by weight):

| | |
|---|---|
| Compound 1 | 20 |
| sodium-lauryl-sulphate | 3 |
| sodium-lignine-sulphonate | 6 |
| water | 63 |
| kaolin | 8 |

### EXAMPLE 16

### Foliar Spray

Foliar spray is prepared with the following composition (proportions by weight):

| | |
|---|---|
| Compound 3 | 20 |
| alkyl-aryl-sulphonate | 5 |
| water | 75 |

### EXAMPLE 17

### Pearling Agent

Pearling agent is prepared with the following composition (proportions by weight):

| | |
|---|---|
| Compound 2 | 0.25 |
| 2% aqueous solution of | 9.75 |
| polyvinylalcohol | |

The pearling agent preferably is applied as active agent in a quantity of 0.01-0.02 m/m % with respect to the weight of the seed.

### EXAMPLE 18

### Granulate

Granulate is prepared with the following composition (proportions by weight):

| | |
|---|---|
| Compound 9 | 10 |
| limestone-powder | 64 |
| ethylene-glycol | 3 |
| high dispersity silicic acid | 4 |
| sodium-ligninesulphonate | 4 |
| water | 15 |

The mixture of the components preferably is ground in a hammer mill until it reaches the particle size of 5 micron.

### EXAMPLE 19

### Powder Preparation

Powder preparation is prepared with the following composition (proportions by weight):

| | |
|---|---|
| Compound 5 | 50 |
| poly-vinyl-pyrrolidon | 10 |
| silicon-dioxide | 25 |
| china-clay (kaolin) | 15 |

We claim:

1. A method for increasing the tolerance of a cultivated plant against a weather condition stress, comprising treating the plant or a seed thereof with an effective amount of an hydroxylamine compound of formula (I), or a salt thereof. 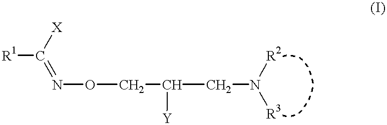
wherein
R¹ represents phenyl, N-heteroaryl, S-heteroaryl or a naphthyl group, any of which is unsubstituted or substituted with one or more halo, alkyl, alkoxy, haloalkyl or nitro, an unsubstituted or substituted phenylamino, alkylamino or lower alkoxy,
X represents halo, amino or an unsubstituted or substituted phenylamino group, or amino substituted with one or two lower alkyl or a hydroxy group provided that if R¹ represents unsubstituted or substituted phenylamino, alkylamino or lower alkoxy, then X is not halo,
Y represents hydrogen, hydroxy or alkanoyloxy,
with the proviso that simultaneously
R¹ may not represent phenyl, halophenyl, alkoxyphenyl, N-heteroaryl or naphthyl,
X may not represent halo, hydroxy or amino and
Y may not represent hydrogen or hydroxy, R² and R³, independently from each other, represent hydrogen or lower alkyl group,
provided that R² and R³ are not hydrogen simultaneously, or R² and R³ along with the nitrogen atom to which they are bonded form a 5 to 7
membered saturated hetero ring.

2. The method of claim 1, wherein X is chloro or bromo.

3. The method of claim 1, wherein Y is C₁₂-C₂₀ alkanoyloxy.

4. The method of claim 1, wherein the seed is treated with an aqueous solution of the hydroxylamine of formula (I).

5. The method of claim 1, wherein said weather condition stress is cold, frost, or a combination thereof

6. The method of claim 5, wherein the seed is treated with an aqueous solution of the hydroxylamine of formula (I).

7. The method of claim 6, comprising soaking the seed in the aqueous solution of the hydroxylamine compound of formula (I).

8. The method of claim 5, comprising coating the seed with the hydroxylamine compound of formula (I).

9. The method of claim 8, wherein the hydroxylamine compound of formula (I) is present in a composition, which comprises
at least one said hydroxylamine compound of formula (I), and
at least one agriculturally acceptable carrier.

10. The method of claim 9, wherein said composition further comprises at least one additional active agent,
at least one germination-improving auxiliary material, or
a mixture thereof.

11. The method of claim 5, comprising spraying the plant to be treated with a solution containing the hydroxylamine compound of formula (I), before or when the cold season begins.

12. The method of claim 1, wherein said weather condition stress is drought, comprising spraying the plant to be treated with a solution containing the hydroxylamine compound of formula (I), before or when a drought period begins.

13. A composition for increasing the tolerance of a cultivated plant against a weather condition stress, comprising:
an hydroxylamine compound of formula (I), or a salt thereof: 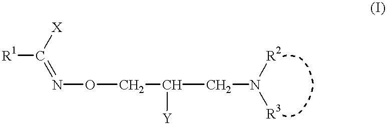
wherein
R¹ represents phenyl, N-heteroaryl, S-heteroaryl or a naphthyl group, any of which is unsubstituted or substituted with one or more halo, alkyl, alkoxy, halo alkyl or nitro, an unsubstituted or substituted phenylamino, alkylamino, or lower alkoxy,
X represents halo, amino or an unsubstituted or substituted phenylamino group, or amino substituted with one or two lower alkyl or a hydroxy group provided that if R¹ represents unsubstituted or substituted phenylamino, alkylamino or lower alkoxy, then X is not halo,
Y represents hydrogen, hydroxy or alkanoyloxy
with the proviso that simultaneously
R¹ may not represent phenyl, halophenyl, alkoxyphenyl, N-heteroaryl or naphthyl,
X may not represent halo, hydroxy or amino and
may not represent hydrogen or hydroxy,
R² and R³, independently from each other, represent hydrogen or lower alkyl group, provided that R² and R³ are not hydrogen simultaneously,
or R² and R³ along with the nitrogen atom to which they are bonded form a 5 to 7 membered saturated hetero ring; and
at least one agriculturally acceptable carrier.

14. The composition of claim 13, wherein said at least one agriculturally acceptable carrier is a solid or liquid carrier.

15. The composition of claim 13, further comprising at least one agriculturally acceptable auxiliary material.

16. The composition of claim 13, wherein
R¹ is unsubstituted or substituted phenyl, and
X is unsubstituted or substituted phenylamino group.

17. The composition of claim 13, comprising N-{(3-(1,1-dimethyl-ethyl)-amino)-2-hydroxy-propoxy}-N-phenyl-benzamidine hydrochloride.

18. The composition of claim 13, comprising N-(3-(1-piperidinyl)-propoxy-N′-phenyl-benzamidine hydrochloride.

19. A hydroxylamine compound of formula (I) or a salt thereof: 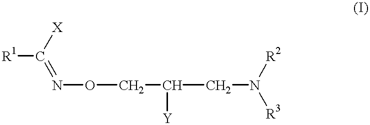
wherein
R¹ is phenyl which is unsubstituted or substituted with one or more halo, alkyl, alkoxy, haloalkyl and nitro,
X is unsubstituted or substituted phenylamino,
Y is hydrogen, hydroxy or alkanoyloxy
R² and R³ independently from each other are H or lower alkyl provided that at least one of them is not hydrogen, or
R² and R³ together with the nitrogen to which they are bonded, form a 5 to 7-membered saturated hetero ring.

20. N-{(3-(1,1-dimethyl-ethyl)-amino)-2-hydroxy-propoxy}-N′-phenyl-benzamidine hydrochloride.

21. N-(3-(1-piperidinyl)-propoxy)-N′-phenyl-benzamidine hydrochloride.
